(19) United States
(12) Patent Application Publication
(10) Pub. No.: US 2026/0308976 A1
(43) Pub. Date: Oct. 8, 2026

(54) CORDLESS STEEL TAPE STABILIZATION SYSTEM

(71) Applicant: Yuyao Hujia Window Decoration Co., Ltd., Ningbo (CN)

(72) Inventors: Qiuping XU, Ningbo (CN); Zhangcai WU, Ningbo (CN)

(21) Appl. No.: 19/462,281

(22) Filed: Jan. 28, 2026

(30) Foreign Application Priority Data
Dec. 10, 2025 (CN) 202522619478.9

(51) Int. Cl. E06B 9/60; E06B 9/42

(52) U.S. Cl. CPC E06B 9/60; E06B 9/42

(57) ABSTRACT

A cordless steel tape stabilization system for controlling unwinding and winding of a shade cloth, including a casing assembly rotatable about an axis thereof and configured to wind the shade cloth, a transmission assembly provided within the casing assembly, and a steel tape. The transmission assembly includes a sun shaft, a planet shaft, a winding shaft and an unwinding shaft. The planet shaft is configured to engage with the sun shaft, and is drivably connected to the casing assembly, so as to be driven by the casing assembly to rotate around the sun shaft. The planet shaft is rotatably connected to the casing assembly to remain rotatable about its axis while rotating around the sun shaft. The unwinding shaft is rotatably connected to the casing assembly. The steel tape is sleeved around an outer periphery of the unwinding shaft in a coiled manner.

### CROSS-REFERENCE TO RELATED APPLICATIONS

This application claims the benefit of priority from Chinese Patent Application No. 202522619478.9, filed on Dec. 10, 2025. The content of the aforementioned application, including any intervening amendments made thereto, is incorporated herein by reference in its entirety.

### TECHNICAL FIELD

This application relates to curtain mechanisms, and more particularly to a cordless steel tape stabilization system.

### BACKGROUND

A steel tape-based mechanism is generally mounted on a roller shade to provide an upward pulling force for the cloth, so as to counterbalance the cloth weight. The more the cloth is pulled downward, the greater deformation the steel tape undergoes, thereby balancing the weight to enable the shade cloth to stop at any desired height.

In the existing steel tape-based mechanisms, a steel tape having a tendency to remain flat is wound into a loop, with an outer end fixed to a mechanism housing and an inner end fixed to a rotating shaft. When the roller shade is pulled, the rotating shaft is rotated to drive the steel tape to be wound inward.

However, such configuration suffers from the following deficiencies.

(1) Since the steel coil is formed by winding a steel tape that is straight in a natural state, the steel tape inherently has a tendency to flatten and thus provides an initial pulling force to the shade cloth; as a result, it is necessary to introduce a counterweight to balance the preset pulling force. In the absence of a counterweight, the initial pulling operation of the roller shade will require a relatively large force; meanwhile, after the roller shade is pulled, the shade cloth will be pulled upward by a small distance when the external force disappears, failing to enable the shade cloth to accurately stop at any desired position. (2) As the shade cloth is pulled downward, the center of the steel coil becomes increasingly tensioned, such that the pulling force generated by the steel tape is actually non-uniform; particularly when applied to a dual-layer roller shade, such non-uniform pulling force will cause the inner and outer layers of the shade cloth to fail to properly align with a light-blocking layer, thereby failing to achieve the complete shading.

### SUMMARY

An object of the disclosure is to provide a cordless steel tape stabilization system, which enables the user to pull a curtain with a relatively-small and uniform force, and enable the curtain to remain securely in position without any bounce-back after released.

Technical solutions of the present disclosure are described as follows.

A cordless steel tape stabilization system, the cordless steel tape stabilization system being configured for controlling winding and unwinding of a shade cloth, and the cordless steel tape stabilization system comprising:

a casing assembly, configured to be rotatable to wind the shade cloth;

a transmission assembly provided within the casing assembly; and

a steel tape;

wherein the transmission assembly comprises a sun shaft, a planet shaft, a winding shaft and an unwinding shaft;

the sun shaft is fixed, and is coaxially arranged with the casing assembly;

the planet shaft is configured to engage with an outer side of the sun shaft, and is drivably connected to the casing assembly, so as to be driven by the casing assembly to rotate around the sun shaft;

the planet shaft is also rotatably connected to the casing assembly to remain rotatable about an axis of the planet shaft while rotating around the sun shaft;

the winding shaft is drivably connected to the planet shaft to be driven to rotate about an axis of the winding shaft;

the unwinding shaft is provided on the same vertical plane as the winding shaft, and is arranged parallel to the winding shaft; and the unwinding shaft is rotatably connected to the casing assembly; and

the steel tape is sleeved around an outer side of the unwinding shaft in a coiled manner; and an outer end of the steel tape is connected integrally with the winding shaft.

In some embodiments, the casing assembly comprises a first casing, a second casing, a mounting base, a cover and a liner;

at least one of the cover, at least one of the second casing, the first casing and the mounting base are sequentially connected end-to-end in a detachable manner to form an integral structure;

a side of the first casing adjacent to the mounting base is provided with a slot; and the liner is sleevedly provided in the slot to prevent rotation and limit movement;

the liner and an inner wall of the first casing are configured to enclose a first chamber; and an engagement portion between the sun shaft and the planet shaft is located in the first chamber; and

an inner wall of the second casing and an inner wall of the cover are configured to enclose a second chamber; and the steel tape, the winding shaft and the unwinding shaft are provided in the second chamber.

In some embodiments, a first end of the sun shaft is configured as a gear portion provided with a gear, and a second end of the sun shaft is configured as a limiting portion having a diameter greater than that of the gear portion;

the gear portion is located within the first casing, and the limiting portion is located within the mounting base;

a stepped surface is provided between the gear portion and the limiting portion, and is configured to abut against an end surface of the liner;

an outer periphery of the limiting portion is sleevedly provided with a bearing; and an outer ring of the bearing is embedded in an inner wall of the casing assembly, such that the casing assembly is rotatable with respect to the sun shaft;

the outer periphery of the limiting portion and the inner wall of the casing assembly are each provided with a raised limiting step; and

an inner ring of the bearing is configured to abut against the raised limiting step of the limiting portion, and the outer ring of the bearing is configured to abut against the raised limiting step of the casing assembly, such that the bearing is axially retained.

In some embodiments, end surfaces of the first casing and the second casing that are adjacent to each other are engaged in a male-female fitting manner;

end surfaces of the cover and the second casing that are adjacent to each other are engaged in the male-female fitting manner;

at least one of the first casing, the at least one of the cover and the at least one of the second casing are screwedly fastened together; and

the first casing and the mounting base are screwedly fastened together.

In some embodiments, two first limiting protrusions are symmetrically arranged on outer peripheral surfaces at two sides of the first casing;

two mounting lugs are symmetrically arranged on outer peripheral surfaces at two sides of the second casing; and each of the two mounting lugs is configured to extend along an axial direction of a mechanism toward the first casing;

end surfaces between the first casing and the second casing are positioned via the male-female fitting manner;

the two mounting lugs are respectively engaged with the two first limiting protrusions, such that the second casing is fixed to the first casing; and

two second limiting protrusions are symmetrically arranged on outer peripheral surfaces at two sides of the cover, and are configured to respectively engage with the two mounting lugs.

In some embodiments, the two sides of the first casing are each provided with a groove configured to receive one of the two mounting lugs, so as to achieve positioning.

In some embodiments, a plurality of second casings and a plurality of covers are provided;

the plurality of second casings and the plurality of covers are alternately arranged in an axial direction of a mechanism toward the first casing to form a plurality of groups, with each group consisting of a second casing and a cover, wherein the second casing is positioned before the cover; and

for adjacent two groups among the plurality of groups, the cover of a former group is detachably connected to the second casing of a latter group.

In some embodiments, a center portion of the mounting base is provided with a first hole for mounting the sun shaft; and the first hole is configured to penetrate through the mounting base;

an end surface of the first casing away from the mounting base is provided with a second hole and a third hole;

an end surface of the liner adjacent to the mounting base is provided with a fourth hole and a fifth hole;

an end surface of the second casing adjacent to the first casing is provided with a sixth hole and a seventh hole;

the cover is provided with an eighth hole and a ninth hole;

the fourth hole is coaxial with the second hole and the first hole;

the fifth hole is coaxial with the third hole, the seventh hole, and the ninth hole;

the eighth hole is coaxial with the sixth hole;

the sun shaft is configured to sequentially pass through the first hole, the fourth hole, and the second hole;

two ends of the planet shaft are respectively configured to extend through the fifth hole and the third hole; and the planet shaft is configured to rotate about an axis thereof;

the winding shaft and the unwinding shaft are axially positioned within the second chamber by a stepped configuration;

a first end of the winding shaft is provided with an anti-rotation hole, and an outer side of an end of the planet shaft adjacent to the first end of the winding shaft is provided with a first anti-rotation flat, such that the winding shaft is sleeved on the outer side of the end of the planet shaft in an anti-rotational and limited manner, and is configured to extend through the seventh hole;

a second end of the winding shaft is supported in the ninth hole, and is provided with a second anti-rotation flat cooperating with the anti-rotation hole, such that the planet shaft is configured to drive the winding shaft to rotate around the sun shaft while simultaneously rotating about an axis of the winding shaft;

the unwinding shaft is arranged spaced apart from the winding shaft; and

two ends of the unwinding shaft are respectively configured to extend through the sixth hole and the eighth hole, such that the unwinding shaft is rotatable about an axis thereof.

In some embodiments, the steel tape is configured to be coiled in a natural state, and is sleeved around an outer periphery of the unwinding shaft in a coiled manner.

In some embodiments, a limiting block is fixedly provided on an outer periphery of the winding shaft; a free end of an outer side of the steel tape is provided with a limiting notch; and the limiting notch and the limiting block are engaged with each other to connect the steel tape to the unwinding shaft.

Compared to the prior art, the present disclosure has the following beneficial effects.
1. Unlike conventional designs where a wound steel tape has an outer diameter approximately equal to that of the casing assembly, the winding shaft of the present disclosure has a diameter substantially smaller than that of the casing assembly. As a result, the same rotation of the casing assembly requires a shorter length of the steel tape, thereby lowering steel tape consumption.
2. The steel tape is configured to be coiled in a natural state, such that, under the action of the transmission assembly, it can be unwound and stretched or rewound and retracted. As a result, when a user pulls the curtain, no additional effort is required to overcome initial tension of the steel tape, so the required pulling force is relatively small and operation is convenient. During the process of pulling the steel tape, the applied pulling force remains substantially uniform at each stage of movement, preventing an increase in force as the curtain is drawn and providing a consistent and comfortable user experience. Furthermore, because the tension generated by the steel tape varies in a substantially uniform manner, the curtain does not rebound upward due to excessive pulling force after released.

### BRIEF DESCRIPTION OF THE DRAWINGS

FIG. 1 schematically shows a general structure of a cordless steel tape stabilization system according to an embodiment of the present disclosure;

FIG. 2 schematically shows another general structure of the cordless steel tape stabilization system according to an embodiment of the present disclosure;

FIG. 3 schematically shows an internal structure of a winding shaft and an unwinding shaft according to an embodiment of the present disclosure;

FIG. 4 is a structural diagram of a transmission assembly according to an embodiment of the present disclosure;

FIG. 5 schematically shows an internal structure of the cordless steel tape stabilization system according to an embodiment of the present disclosure;

FIG. 6 is a structural diagram of a mounting base according to an embodiment of the present disclosure;

FIG. 7 is a structural diagram of a liner according to an embodiment of the present disclosure;

FIG. 8 is a structural diagram of a first casing according to an embodiment of the present disclosure;

FIG. 9 is a structural diagram of a second casing according to an embodiment of the present disclosure; and

FIG. 10 schematically shows a limiting notch of a steel tape according to an embodiment of the present disclosure.

### IN THE FIGURES

1-casing assembly; 11-first casing; 111-limiting protrusion; 112-second hole; 113-third hole; 12-second casing; 121-mounting lug; 122-sixth hole; 123-seventh hole; 13-mounting base; 131-first hole; 14-cover; 15-screw; 16-liner; 161-fourth hole; 162-fifth hole; 2-transmission assembly; 21-sun shaft; 211-sun gear; 22-planet shaft; 221-planet gear; 23-winding shaft; 231-limiting block; 24-unwinding shaft; 25-bearing; 3-steel tape; and 31-limiting notch.

### DETAILED DESCRIPTION OF EMBODIMENTS

### EMBODIMENT 1

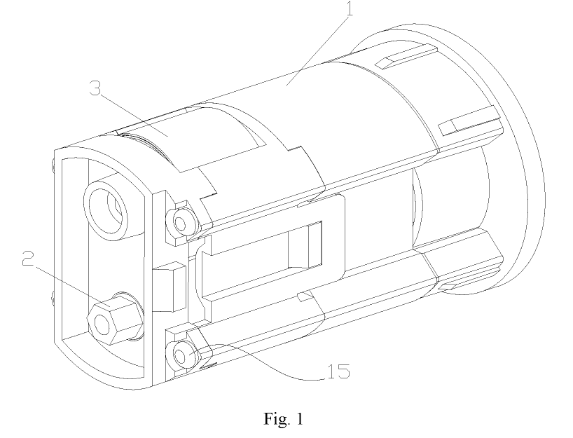

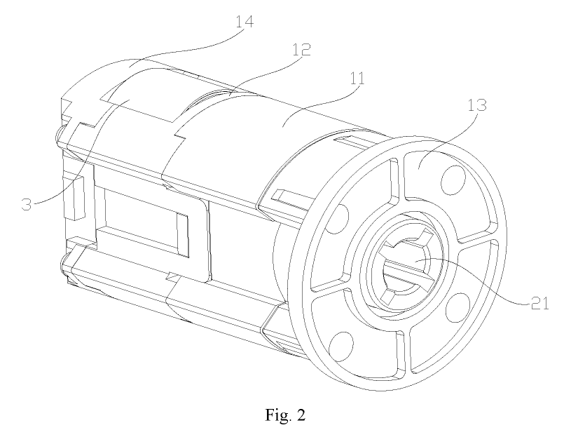

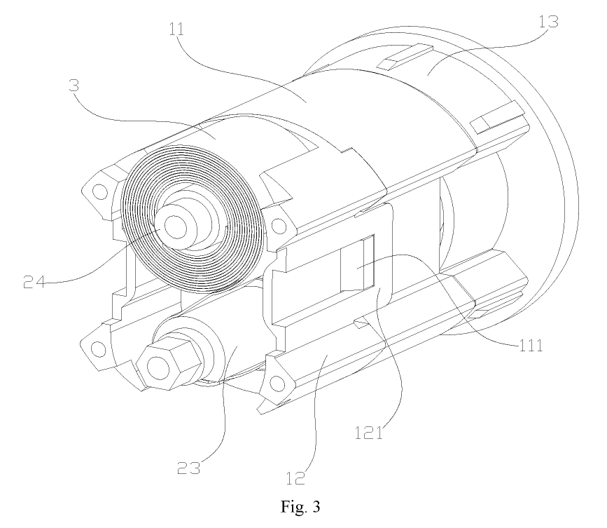

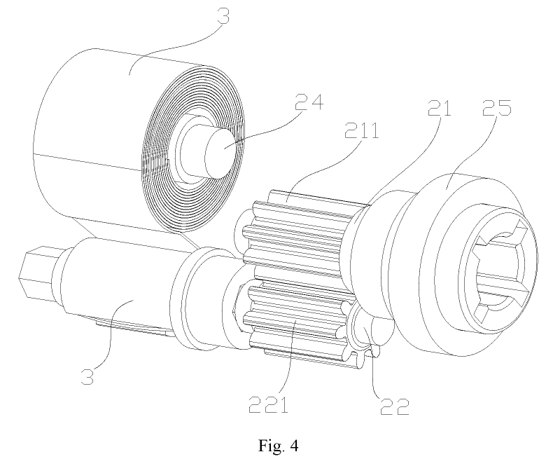

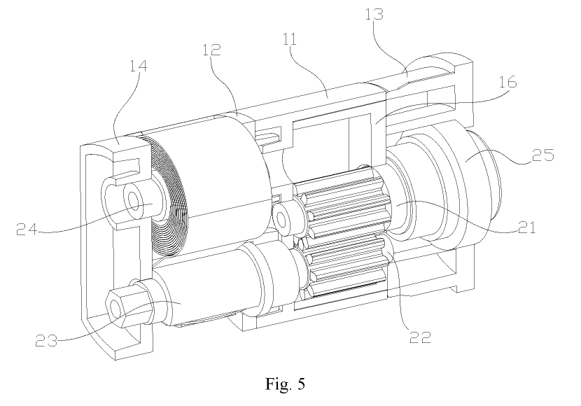

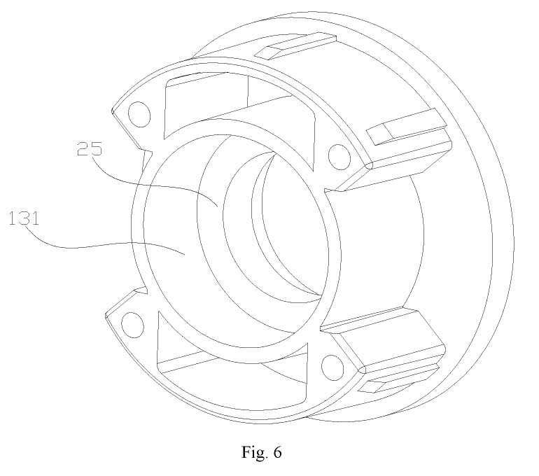

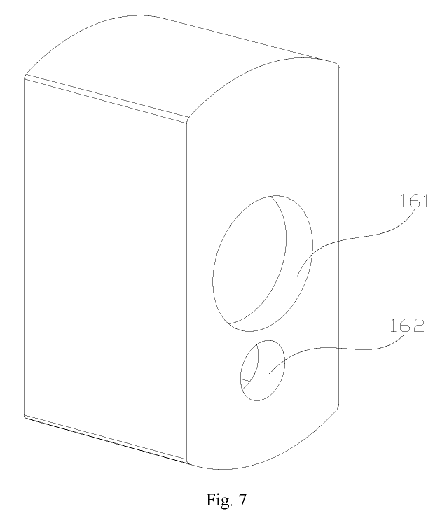

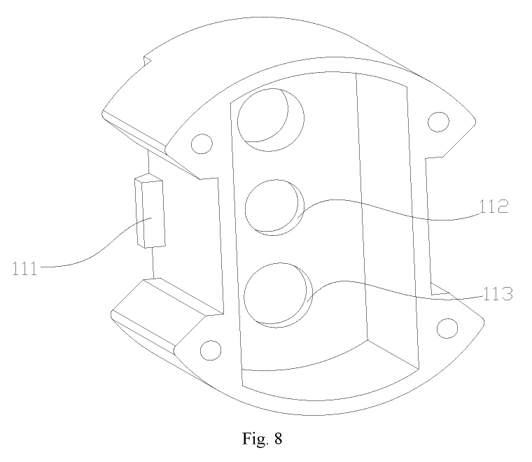

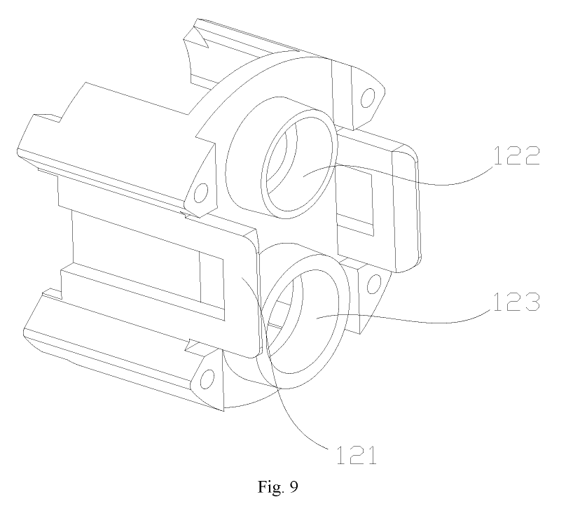

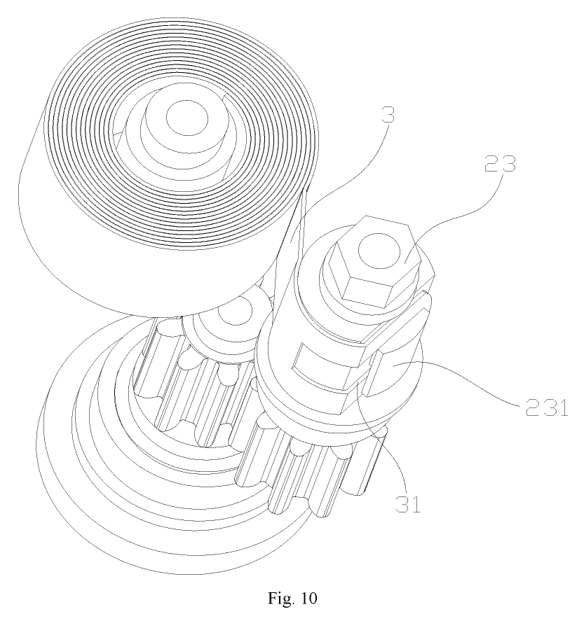

Referring to FIGS. 1-10, an embodiment of the present disclosure provides a cordless steel tape stabilization system, and the cordless steel tape stabilization system is configured for controlling winding and unwinding of a shade cloth. The cordless steel tape stabilization system includes a casing assembly 1, a transmission assembly 2, and a steel tape 3. The transmission assembly 2 is provided within an internal chamber of the casing assembly 1. The steel tape 3 is configured to be rewound and unwound by the transmission assembly 2.

The casing assembly 1 includes a first casing 11, a second casing 12, a mounting base 13, a cover 14 and a liner 16. The cover 14, the second casing 12, the first casing 11 and the mounting base 13 are sequentially connected end to end to form a chamber for accommodating the transmission assembly 2.

A center portion of the mounting base 13 is provided with a first hole 131, and the first hole 131 is configured to extend through the mounting base.

The first casing 11 is configured to abut against an end surface of the mounting base 13, and is configured to be fastened to the mounting base 13 by a screw 15. An end surface of the first casing 11 away from the mounting base 13 is provided with a second hole 112 and a third hole 113. A side of the first casing badjacent to the mounting base 13 is provided with a slot. The liner 16 is sleevedly provided in the slot to prevent rotation and limit movement. The liner 16 and an inner wall of the first casing 11 are configured to enclose a first chamber. An end surface of the liner 16 facing a side of the mounting base 13 is configured to abut against and be secured to the mounting base 13. The end surface of the liner 16 adjacent to the side of the mounting base 13 is provided with a fourth hole 161 and a fifth hole 162. The fourth hole 161 is coaxial with the second hole 112 and the first hole 131, and the fifth hole 162 is coaxial with the third hole 113.

Two first limiting protrusions 111 are symmetrically arranged on outer peripheral surfaces at two sides of the first casing 11. Two mounting lugs 121 are symmetrically arranged on outer peripheral surfaces at two sides of the second casing 12. Each mounting lug 121 is configured to extend along an axial direction of a mechanism toward the first casing 11. End surfaces between the first casing 11 and the second casing 12 are positioned via a male-female fitting manner. The two sides of the first casing 11 are each provided with a groove configured to receive one of the two mounting lugs 121, thereby achieving positioning. The two mounting lugs 121 are respectively engaged with the two first limiting protrusions 111, such that the second casing 12 is fixed to the first casing 11.

An end surface of the second casing 12 adjacent to the first casing 11 is provided with a sixth hole 122 and a seventh hole 123. The seventh hole 123 is coaxial with the third hole 113 and the fifth hole 162.

End surfaces between the cover 14 and the second casing 12 are positioned via the male-female fitting manner. The cover 14, the second casing 12, and the first casing 11 are fixed by screws 15. An inner wall of the cover 14 and an inner wall of the second casing 12 are configured to enclose a second chamber. The second chamber is open at both the top and bottom. Two second limiting protrusions 111 are symmetrically arranged on outer peripheral surfaces at two sides of the cover 14. The cover 14 is provided with an eighth hole and a ninth hole. The eighth hole is coaxial with the sixth hole 122, and the ninth hole is coaxial with the seventh hole 123. The eighth hole and the ninth hole are symmetrically arranged with respect to a central axis of the mechanism. The sixth hole 122 and the seventh hole 123 are symmetrically arranged with respect to a central axis of the mechanism.

The transmission assembly 2 includes a sun shaft 21, a planet shaft 22, a winding shaft 23 and an unwinding shaft 24.

The sun shaft 21 is configured to sequentially pass through the first hole 131, the fourth hole 161 and the second hole 112. A first end of the sun shaft 21 is configured as a gear portion provided with a sun gear 211, and a second end of the sun shaft 21 is configured as a limiting portion having a diameter greater than that of the gear portion. The gear portion is located within the first chamber. The limiting portion is located within the first hole 131. A stepped surface is provided between the gear portion and the limiting portion, and is configured to abut against the end surface of the liner 16. An outer periphery of the limiting portion is sleevedly provided with a bearing 25. An outer ring of the bearing 25 is embedded in an inner wall of the first hole 131, such that the casing assembly 1 is rotatable with respect to the sun shaft 21. The outer periphery of the limiting portion and the inner wall of the casing assembly 1 are each provided with a raised limiting step. An inner ring of the bearing 25 is configured to abut against the raised limiting step of the limiting portion, and the outer ring of the bearing 25 is configured to abut against the raised limiting step of and the casing assembly 1, such that the bearing 25 is axially retained. A tail end of the sun shaft 21 is provided with a cross-shaped notch for connection with an externally provided fixed bracket, such that the sun shaft 21 is fixed. In some embodiments, an outer peripheral surface of the sun shaft 21 is in direct contact with an inner side wall of the first hole 131.

The planet shaft 22 is located in the first chamber, and is provided on an outer side of the sun shaft 21. Two ends of the planet shaft 22 are respectively configured to extend through the fifth hole 162 and the third hole 113. The planet shaft 22 is configured to rotate about an axis of the planet shaft 22. A planet gear 221 is fixedly mounted on an outer side of the planet shaft 22. The planet gear 221 is configured to engage with the sun gear 211, such that the planet gear 221 is driven, due to rotation of the casing assembly 1, to rotate around the sun gear 211 while also rotating about an axis of the planet gear 221.

The winding shaft 23 and the unwinding shaft 24 are axially positioned within the second chamber by a stepped configuration. A first end of the winding shaft 23 is provided with an anti-rotation hole, and an outer side of an end of the planet shaft 22 adjacent to the first end of the winding shaft 23 is provided with a first anti-rotation flat, such that the winding shaft 23 is sleeved on the outer side of the end of the planet shaft 22 in an anti-rotational and limited manner, and is configured to extend through the seventh hole 123. A second end of the winding shaft 23 is supported in the ninth hole, and is provided with a second anti-rotation flat cooperating with the anti-rotation hole, such that the planet shaft 22 is configured to drive the winding shaft 23 to rotate around the sun shaft 21 while simultaneously rotating about an axis of the winding shaft 23. The unwinding shaft 24 is arranged spaced apart from the winding shaft 23. Two ends of the unwinding shaft 24 are respectively configured to extend through the sixth hole 122 and the eighth hole, such that the unwinding shaft 24 is rotatable about an axis thereof. It should be noted that an end of the unwinding shaft 24 located within the eighth hole does not fully occupy the eighth hole, but occupies approximately half thereof.

The steel tape 3 is configured to be coiled in a natural state rather than a flat state, and is sleeved around an outer periphery of the unwinding shaft 24 in a coiled manner. A limiting block 231 is fixedly provided on the outer periphery of the winding shaft 23. A free end of an outer side of the steel tape 3 is provided with a limiting notch 31. The limiting notch 31 and the limiting block 231 are engaged with each other to connect the steel tape 3 to the unwinding shaft 24. After mounting the steel tape 3, the steel tape 3 can be observed from an opening of the second chamber.

The operation principle of the present disclosure is as follows.

During installation, the above-described cordless steel tape stabilization system is embedded into a sleeve of the curtain. An outer side of the sleeve is connected to the shade cloth. The sleeve is rotatable to wind or unwind the shade cloth. The sun shaft 21 is fixedly connected to a wall via an externally provided bracket.

When the shade cloth is pulled downward or raised upward, the sleeve rotates and drives the casing assembly 1 to rotate. Because the sun shaft 21 is fixed, the planet shaft 22 is driven by the casing assembly 1 to rotate around the sun shaft 21. Simultaneously, due to the engagement between the sun gear 211 and the planet gear 221, the planet shaft 22 also rotates about an axis thereof. The rotation of the planet shaft 22 about its own axis further drives the winding shaft 23 to rotate about an axis of the winding shaft 23. The direction of rotation of the planet shaft 22 about its own axis determines whether the steel tape 3 is rewound or released. When the shade cloth is pulled downward and the planet shaft 22 rotates in the forward direction, the winding shaft 23 rotates to draw out the steel tape 3, causing the steel tape 3 to be rewound onto the winding shaft 23. Since the steel tape 3 inherently tends to coil, as more of the steel tape 3 is wound onto the winding shaft 23, a greater pulling force is generated by the steel tape 3, thereby providing an increased pulling force during downward pulling of the shade cloth and preventing the shade cloth from descending under its own weight.

Since the steel tape 3 is coiled in a natural state, during downward pulling of the shade cloth, the elastic force generated by the steel tape 3 increases in a substantially uniform manner and does not progressively increase as the pulling continues, thereby preventing the shade cloth from being lifted upward due to excessive pulling force of the steel tape 3 when the downward pulling is stopped, and ensuring that the shade cloth can be stopped at any desired position.

Moreover, because the steel tape 3 is continuously wound around the winding shaft 23, and an outer diameter of the winding shaft 23 is significantly smaller than an outer diameter of the sleeve and an outer diameter of the casing assembly 1, a substantially shorter length of the steel tape 3 is required for winding or unwinding the same length of shade cloth. For example, when the shade cloth is fully extended, the casing assembly 1 rotates 30 revolutions, and the winding shaft 23 correspondingly also rotates 30 revolutions. However, due to the smaller outer diameter of the winding shaft 23, less steel tape 3 is taken up per revolution, such that the total length of the steel tape 3 required over the same number of revolutions is significantly reduced.

Additionally, when the length of the shade cloth is excessive, the number of steel tapes 3 can be increased. Specifically, , an additional second casing 12, a steel tape 3, a winding shaft 23, an unwinding shaft 24, and a cover 14 are mounted on the end surface of the cover 14 in an axial direction toward a center of the shade cloth. The additionally mounted winding shaft 23 is axially sleeved with the original winding shaft 23 in a non-rotatable manner to form an integrated assembly. A first end of the additionally mounted unwinding shaft 24 is provided within the eighth hole of the original cover 14, and a second end of the additionally mounted unwinding shaft 24 is provided within the eighth hole of the additionally mounted cover 14. The additionally mounted second casing 12 can also be integrally connected to the cover 14 by snap-engagement of the mounting lugs 121 and the limiting protrusions 111.

Described above are merely preferred embodiments of the present disclosure, and are not intended to limit the scope of the present disclosure. It should be understood that various modifications, changes and replacements made by those skilled in the art without departing from the spirit of the disclosure shall fall within the scope of the present disclosure defined by the appended claims.

What is claimed is:

1. A cordless steel tape stabilization system, the cordless steel tape stabilization system being configured for controlling winding and unwinding of a shade cloth, and the cordless steel tape stabilization system comprising:
a casing assembly, configured to be rotatable to wind the shade cloth;
a transmission assembly provided within the casing assembly; and
a steel tape;
wherein the transmission assembly comprises a sun shaft, a planet shaft, a winding shaft and an unwinding shaft;
the sun shaft is fixed, and is coaxially arranged with the casing assembly;
the planet shaft is configured to engage with an outer side of the sun shaft, and is drivably connected to the casing assembly, so as to be driven by the casing assembly to rotate around the sun shaft;
the planet shaft is also rotatably connected to the casing assembly to remain rotatable about an axis of the planet shaft while rotating around the sun shaft;
the winding shaft is drivably connected to the planet shaft to be driven to rotate about an axis of the winding shaft;
the unwinding shaft is provided on the same vertical plane as the winding shaft, and is arranged parallel to the winding shaft; and the unwinding shaft is rotatably connected to the casing assembly; and
the steel tape is sleeved around an outer side of the unwinding shaft in a coiled manner; and an outer end of the steel tape is connected integrally with the winding shaft.

2. The cordless steel tape stabilization system of claim 1, wherein the casing assembly comprises a first casing, a second casing, a mounting base, a cover and a liner;
at least one of the cover, at least one of the second casing, the first casing and the mounting base are sequentially connected end-to-end in a detachable manner to form an integral structure;
a side of the first casing adjacent to the mounting base is provided with a slot; and the liner is sleevedly provided in the slot to prevent rotation and limit movement;
the liner and an inner wall of the first casing are configured to enclose a first chamber; and an engagement portion between the sun shaft and the planet shaft is located in the first chamber; and
an inner wall of the second casing and an inner wall of the cover are configured to enclose a second chamber; and the steel tape, the winding shaft and the unwinding shaft are provided in the second chamber.

3. The cordless steel tape stabilization system of claim 2, wherein a first end of the sun shaft is configured as a gear portion provided with a gear, and a second end of the sun shaft is configured as a limiting portion having a diameter greater than that of the gear portion;
the gear portion is located within the first casing, and the limiting portion is located within the mounting base;
a stepped surface is provided between the gear portion and the limiting portion, and is configured to abut against an end surface of the liner;
an outer periphery of the limiting portion is sleevedly provided with a bearing; and an outer ring of the bearing is embedded in an inner wall of the casing assembly, such that the casing assembly is rotatable with respect to the sun shaft;
the outer periphery of the limiting portion and the inner wall of the casing assembly are each provided with a raised limiting step; and
an inner ring of the bearing is configured to abut against the raised limiting step of the limiting portion, and the outer ring of the bearing is configured to abut against the raised limiting step of the casing assembly, such that the bearing is axially retained.

4. The cordless steel tape stabilization system of claim 2, wherein end surfaces of the first casing and the second casing that are adjacent to each other are engaged in a male-female fitting manner;
end surfaces of the cover and the second casing that are adjacent to each other are engaged in the male-female fitting manner;
at least one of the first casing, the at least one of the cover and the at least one of the second casing are screwedly fastened together; and
the first casing and the mounting base are screwedly fastened together.

5. The cordless steel tape stabilization system of claim 4, wherein two first limiting protrusions are symmetrically arranged on outer peripheral surfaces at two sides of the first casing;
two mounting lugs are symmetrically arranged on outer peripheral surfaces at two sides of the second casing; and each of the two mounting lugs is configured to extend along an axial direction of a mechanism toward the first casing;
end surfaces between the first casing and the second casing are positioned via the male-female fitting manner;
the two mounting lugs are respectively engaged with the two first limiting protrusions, such that the second casing is fixed to the first casing; and
two second limiting protrusions are symmetrically arranged on outer peripheral surfaces at two sides of the cover, and are configured to respectively engage with the two mounting lugs.

6. The cordless steel tape stabilization system of claim 5, wherein the two sides of the first casing are each provided with a groove configured to receive one of the two mounting lugs, so as to achieve positioning.

7. The cordless steel tape stabilization system of claim 2, wherein a plurality of second casings and a plurality of covers are provided;
the plurality of second casings and the plurality of covers are alternately arranged in an axial direction of a mechanism toward the first casing to form a plurality of groups, with each group consisting of a second casing and a cover, wherein the second casing is positioned before the cover; and
for adjacent two groups among the plurality of groups, the cover of a former group is detachably connected to the second casing of a latter group.

8. The cordless steel tape stabilization system of claim 2, wherein a center of the mounting base is provided with a first hole for mounting the sun shaft; and the first hole is configured to penetrate through the mounting base;
an end surface of the first casing away from the mounting base is provided with a second hole and a third hole;
an end surface of the liner adjacent to the mounting base is provided with a fourth hole and a fifth hole;
an end surface of the second casing adjacent to the first casing is provided with a sixth hole and a seventh hole;
the cover is provided with an eighth hole and a ninth hole;
the fourth hole is coaxial with the second hole and the first hole;
the fifth hole is coaxial with the third hole, the seventh hole and the ninth hole;
the eighth hole is coaxial with the sixth hole;
the sun shaft is configured to sequentially pass through the first hole, the fourth hole and the second hole;
two ends of the planet shaft are respectively configured to extend through the fifth hole and the third hole; and the planet shaft is configured to rotate about an axis thereof;
the winding shaft and the unwinding shaft are axially positioned within the second chamber by a stepped configuration;
a first end of the winding shaft is provided with an anti-rotation hole, and an outer side of an end of the planet shaft adjacent to the first end of the winding shaft is provided with a first anti-rotation flat, such that the winding shaft is sleeved on the outer side of the end of the planet shaft in an anti-rotational and limited manner, and is configured to extend through the seventh hole;
a second end of the winding shaft is supported in the ninth hole, and is provided with a second anti-rotation flat cooperating with the anti-rotation hole, such that the planet shaft is configured to drive the winding shaft to rotate around the sun shaft while simultaneously rotating about an axis of the winding shaft;
the unwinding shaft is arranged spaced apart from the winding shaft; and
two ends of the unwinding shaft are respectively configured to extend through the sixth hole and the eighth hole, such that the unwinding shaft is rotatable about an axis thereof.

9. The cordless steel tape stabilization system of claim 1, wherein the steel tape is configured to be coiled in a natural state, and is sleeved around an outer periphery of the unwinding shaft in a coiled manner.

10. The cordless steel tape stabilization system of claim 1, wherein a limiting block is fixedly provided on an outer periphery of the winding shaft; a free end of an outer side of the steel tape is provided with a limiting notch; and the limiting notch and the limiting block are engaged with each other to connect the steel tape to the unwinding shaft.
